(19) United States
(12) Patent Application Publication
(10) Pub. No.: US 2009/0106699 A1
(43) Pub. Date: Apr. 23, 2009

(54) IMAGE PROCESSING DEVICE AND IMAGE PROCESSING METHOD

(76) Inventors: Yuka Kihara, Kanagawa (JP); Koji Kobayashi, Kanagawa (JP); Hirohisa Inamoto, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/208,486

(22) Filed: Sep. 11, 2008

(30) Foreign Application Priority Data
Oct. 23, 2007 (JP) 2007-274699

(51) Int. Cl. G06F 3/048

(52) U.S. Cl. 715/838

(57) ABSTRACT

An object analyzing unit analyzes images read from a storage unit and classifies objects contained in the images by object attribute. A display-method determining unit determines display positions of thumbnails of the images containing each object for every object attribute classified by the object analyzing unit. A thumbnail generating unit generates the thumbnails of the images containing each object, and outputs a thumbnail list image by placing the thumbnails at the display positions determined by the display-method determining unit.

### CROSS-REFERENCE TO RELATED APPLICATIONS

The present application claims priority to and incorporates by reference the entire contents of Japanese priority document 2007-274699 filed in Japan on Oct. 23, 2007.

### BACKGROUND OF THE INVENTION

1. Field of the Invention

The present invention relates to displaying of thumbnail images and searching of images from images in an image database.

2. Description of the Related Art

There exist technologies that enable displaying of thumbnail images to make it convenient to browse through a large number of images stored in a storage device and search for a desired image. A thumbnail image, or a thumbnail, is a shrunk image of a still image, obtained by thinning out pixels from the image. Displaying the thumbnails in the form of a list on a screen enables a user to conveniently browse through a plurality of thumbnails at a time, and to efficiently search for a desired image.

Some technologies enable the user to easily obtain information about the original images from displayed thumbnails. For example, a method is disclosed in Japanese Patent Application Laid-open No. 2001-337994 whereby information pertaining to an original image, such as the file name, creation date, modification date, and security level are stored as tag data in an associated form with the thumbnail of the image. When the thumbnail is displayed, the tag data associated with the thumbnail is retrieved and displayed alongside. Similarly, in a technology disclosed in Japanese Patent Application Laid-open No. 2006-277409, an object display mode is provided to enable a thumbnail display of an object in an image when a particular part of the image such as a person or a number plate is specified. This technology thus helps to reduce the labor and time involved in searching for objects in photographic images.

When searching for an image, users often give an attribute of the image they are searching for in the search query. In this case, a display method is preferable that not only enables the user to obtain the attributes of the original image but also the relation between the displayed thumbnails.

There exist technologies that improve search efficiency by displaying thumbnails in the form of a map (hereinafter, “image map”) based on the attributes of the thumbnails. In an image map, a group of thumbnails that have similar attributes are grouped together and displayed on the screen. The advantage of an image map is that the user can visually identify the thumbnail that he/she is seeking. Technologies disclosed in Japanese Patent No. 3614235, Japanese Patent Application Laid-open No. 2005-55743, and Japanese Patent Application Laid-open No. 2005-235041 relate to image map display methods. For example, in the technology disclosed in Japanese Patent No. 3614235, feature quantity of features such as color, form, size, type, and keyword are extracted from a display target image, and feature quantity vectors are created. The feature quantity vectors are then projected on two-dimensional coordinate axes using a self-organizing map. The density of data is changed and a plurality of screens is lined up in a depth direction to change the view to a three-dimensional view, thus enabling easy search of the required image.

In the method disclosed in Japanese Patent Application Laid-open No. 2005-55743, the attributes of the all the display target images are retrieved, and a center is set on the screen for each attribute value. The attributes of the display target images are retrieved from the concerned images, and the thumbnails of the images are arranged in the vicinity of the center of the attribute values of the images. Thus, the thumbnails of the images having similar attribute values are displayed together. In the method disclosed in Japanese Patent Application Laid-open No. 2005-235041, N-dimensional feature quantity is extracted from the image data, and a new two-dimensional feature quantity is extracted by multivariate statistical analysis. Further, display position and display size are determined based on clustering data.

Often, attributes are used as the key when searching for a photographic image or a graphical image displayed as thumbnails. However, when large numbers of images are involved, search can be performed effectively by looking for objects included in the image and filtering out those images that do not include the objects from the search. Search keywords input by the user and read by an optical character reader (OCR) are generally used when searching for an article or a business document. However, if the user fails to enter appropriate search keyword or if the OCR fails, the article or business document can still be searched from the thumbnails of drawings, tables, and captions by activating the visual feature “include drawings, tables, and captions”. The method of searching through the thumbnails of a specific object, if the document concerned includes drawings, etc. is more effective than searching the text. Thus, a search method that uses a specific object contained in the image is often more effective.

However, the display position is determined image-by-image in the image map display methods disclosed in the technologies described above. Therefore, if the specified object is not one of the principal objects of the image, the object cannot be easily extracted as an attribute of the image.

### SUMMARY OF THE INVENTION

It is an object of the present invention to at least partially solve the problems in the conventional technology.

According to an aspect of the present invention, there is provided an image processing device including a classifying unit that analyzes a display target image and classifies an object included in the display target image based on an attribute of the object; a feature-data retrieving unit that retrieves feature data that indicates a feature of the object; a display-method determining unit that sets, based on the feature data, at least one of a display position and a display size of a thumbnail of the display target image that includes the object; and a thumbnail generating unit that generates the thumbnail of the display target image. The thumbnail generating unit creates a thumbnail list image by at least one of generating the thumbnail in the display size set by the display-method determining unit and arranging the thumbnail in the display position set by the display-method determining unit.

According to another aspect of the present invention, there is provided an image processing device including a classifying unit that analyzes a display target image and classifies an object included in the display target image based on an attribute of the object; a preference setting unit that sets an order of preference of the attributes; a display-method determining unit that sets, based on the order of preference, at least one of a display position and a display size of a thumbnail of the display target image that includes the object; and a thumbnail generating unit that generates the thumbnail of the display target image. The thumbnail generating unit creates a thumbnail list image by at least one of generating the thumbnail in the display size set by the display-method determining unit and arranging the thumbnail in the display position set by the display-method determining unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image processing device according to a first embodiment of the present invention;

FIG. 2 is a listing of object attributes classified by an object analyzing unit shown in FIG. 1;

FIG. 3 is a flowchart of a thumbnail list image display process performed by the image processing device shown in FIG. 1;

FIG. 4 is a schematic diagram of a thumbnail list image of regular textual images;

FIG. 5 is a magnified view of an object attribute “drawing” denoted by the reference symbol ZM1 and the thumbnails around it;

FIG. 6 is a flowchart of a thumbnail list image display process performed by an image processing device according to a second embodiment of the present invention;

FIG. 7 is a schematic diagram of a thumbnail list image of regular textual images input as display target images;

FIG. 8 is a magnified view of an object attribute “drawing” denoted by the reference symbol ZM1′ and the thumbnails around it;

FIG. 9 is a flowchart of a thumbnail list image display process performed by an image processing device according to a third embodiment of the present invention;

FIG. 10 is a schematic diagram of a thumbnail list image in which the display sizes of the thumbnails have been varied depending on an order of preference; and

FIG. 11 is a flowchart of a thumbnail list image display process performed by an image processing device according to a fourth embodiment of the present invention.

### DETAILED DESCRIPTION OF THE PREFERRED EMBODIMENTS

Exemplary embodiments of the present invention are described below with reference to the accompanying drawings.

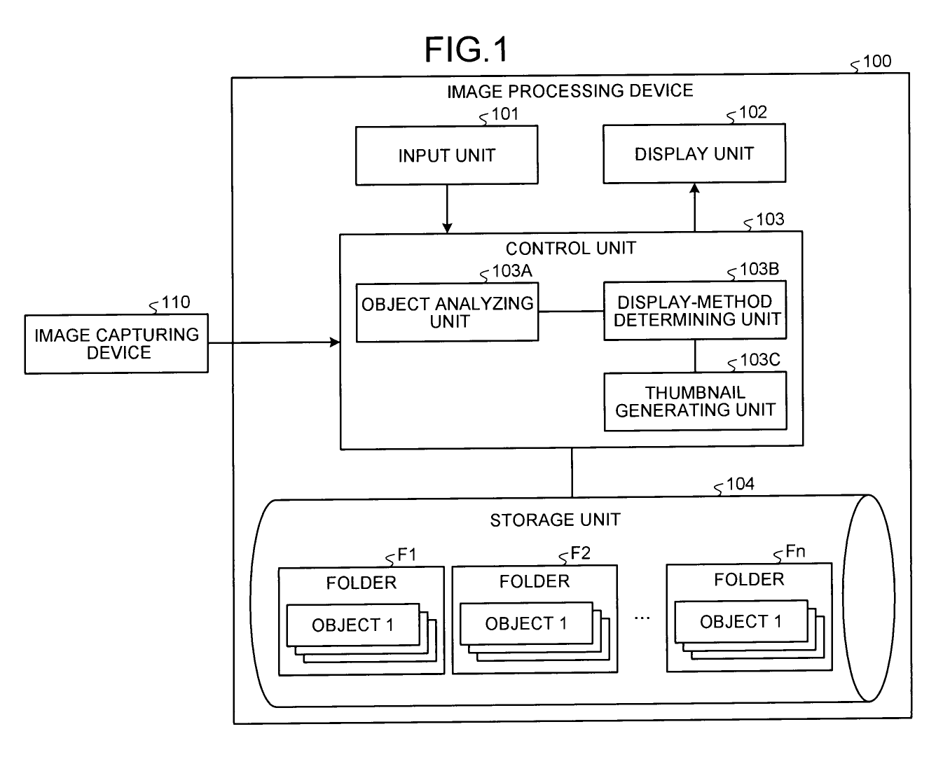

FIG. 1 is a block diagram of an image processing device 100 according to a first embodiment of the present invention. The image processing device 100 includes an input unit 101, a display unit 102, a control unit 103, and a storage unit 104. The input unit 101 can be a keyboard and/or a pointing device such as a mouse, and is used for inputting search condition specification, adding new search conditions, and modifying existing search conditions. The display unit 102 can be a liquid crystal display or a cathode ray tube (CRT), and displays thumbnails of images based on the search condition as well as instruction request or instruction result of the input unit 101.

The storage unit 104 can be a hard disk, and stores therein images captured by an image capturing device 110 such as a camera, or images of documents such as conference material scanned by a scanner. The storage unit 104 also stores therein the thumbnails and object data of the images as folders F1 to Fn. Object data is data pertaining to captions in an image, objects such as drawings, tables, and graphs in a text document, and objects such as portions of an image in a photographic image. Each piece of object data has a corresponding attribute data. Attribute data can be position data that indicates the position of the object, or image attribute quantity obtained by quantification of image attributes of the object, or the pixel size of the object. The storage unit 104 also stores therein, corresponding to each image, image identification data such as the pixel size and image ID or image name.

The control unit 103 includes a central processing unit (CPU), a read-only memory (ROM), a random access memory (RAM), etc. The control unit 103 causes the image processing device 100 to realize various functions by executing various programs stored in the ROM. The functions realized by the image processing device 100 include those of the object analyzing unit 103A, a display-method determining unit 103B, and a thumbnail generating unit 103C shown in FIG. 1. The object analyzing unit 103A reads the display target image from the storage unit 104, analyzes the image, extracts the attribute of the object (object attribute) in the image, classifies the objects by object attribute, associates the object attribute to the object, and adds it to the object data.

The object analyzing unit 103A can use the method disclosed in Japanese Patent Application Laid-open No. 2005-78149 to perform image analysis and object extraction. According to this method, the object analyzing unit 103A divides an image into progressively smaller and smaller areas, and optimizes area boundaries pixel-by-pixel by deploying the Markov random field model that is applicable in spatial frequency domain. Specifically, the object analyzing unit 103A extracts texture attributes of various scales, and divides the image into areas based on the texture attributes. The object analyzing unit 103A then limits its scanning to designated areas and carves out the area of the object with predominant texture attribute. Applying the Markov random field model to the carved out area and the areas surrounding it, the object analyzing unit 103A optimizes the boundary shape between the areas.

The object analyzing unit 103A can use the method disclosed in Japanese Patent Application Laid-open No. 2006-39658 for determining object attributes. Though the method disclosed in the patent application is for determining image attributes, it can be adapted for determining object attributes.

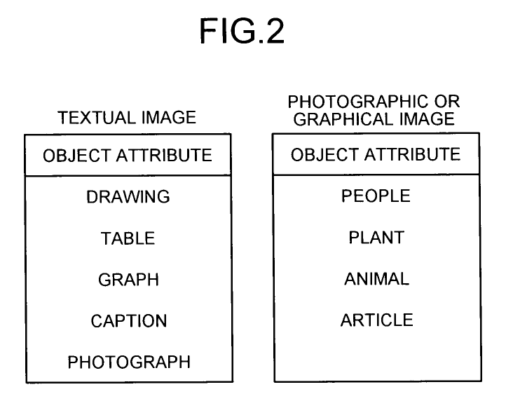

FIG. 2 is a listing of the object attributes classified by the object analyzing unit 103A. Drawings, tables, graphs, captions, etc., are examples of object attributes in a textual image. People, plants, animals, articles, etc., are examples of object attributes in a photographic or graphical image.

The display-method determining unit 103B determines, for each object attribute classified by the object analyzing unit 103A, the display positions of the thumbnails of the images that contain the object. The thumbnail generating unit 103C generates the thumbnails of the images that contain the object, and outputs to the display unit 102 a process result in the form of a thumbnail list image in which each thumbnail is arranged in the display position determined by the display-method determining unit 103B.

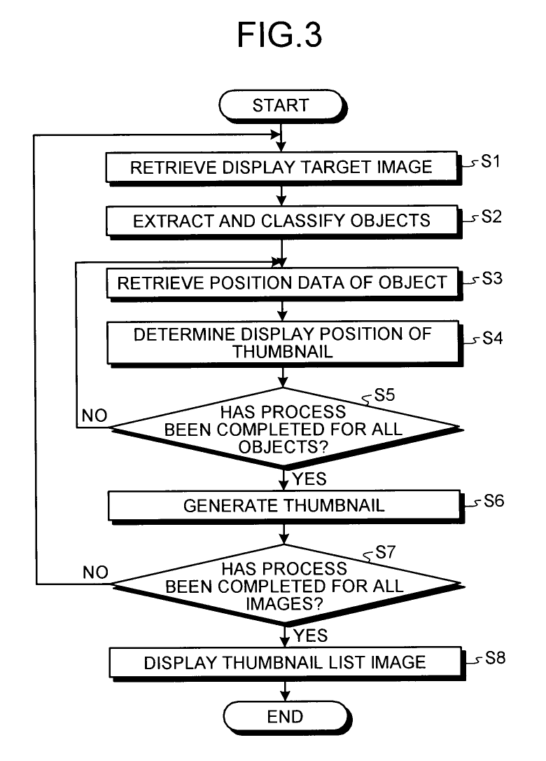

FIG. 3 is a flowchart of a thumbnail list image display process performed by the image processing device 100. The object analyzing unit 103A retrieves a display target image from the storage unit 104 (Step S1), analyzes the image to extract objects from the image, determines object attributes of the objects, and classifies the objects based on their object attributes (Step S2). The object analyzing unit 103A then retrieves the position data that indicates the position of each object in the original display target image (Step S3). For example, if the original display target image is rectangular, at Step S3 the object analyzing unit 103A determines a center of gravity of each object from the coordinates of the upper left and lower right corners of the original display target image, and retrieves coordinates of the center of gravity of an object as the position data of the object.

The display-method determining unit 103B determines the display positions of thumbnails of the display target image that contain the objects (Step S4). Assuming that the size of an object is m×n pixels, the upper left corner of the object is the origin, the size of the display target image is M×N pixels, and the coordinates of the center of gravity of the object in the display target image is (fx,fy), then a display position (x,y) of a thumbnail that is to contain the object can be determined from Equation (1):

$$( x , y ) = ( {f}_{x} \times \frac{m}{M} , {f}_{y} \times \frac{n}{N} ) \qquad ( 1 )$$

The display-method determining unit 103B checks whether the process has been completed for all the objects in the display target image (Step S5). If there is an unprocessed object (No at Step S5), Steps S3 to S5 are repeated for the unprocessed object. If there is no unprocessed object (Yes at Step S5), the thumbnail generating unit 103C generates a thumbnail of the display target image (Step S6), and checks whether the process has been completed for all the display target images (Step S7). If there is no unprocessed display target image (Yes at Step S7), the thumbnail generating unit 103C creates a thumbnail list image in which the thumbnails generated at step S6 are placed at the display positions determined at step S4, and outputs the thumbnail list image to the display unit 102 (Step S8). If there is an unprocessed display target image (No at Step S7), Step S1 to S7 are repeated for the unprocessed display target image.

Suppose that in an image map, a display area is secured for each object attribute and each object attribute is displayed at the designated area. At step S8, the thumbnail generating unit 103C generates the thumbnail list image by arranging the thumbnails on the image map. The display areas of the object attributes in the image map can be preset or can be made changeable with each image according to the number of images, image attribute, or object attribute.

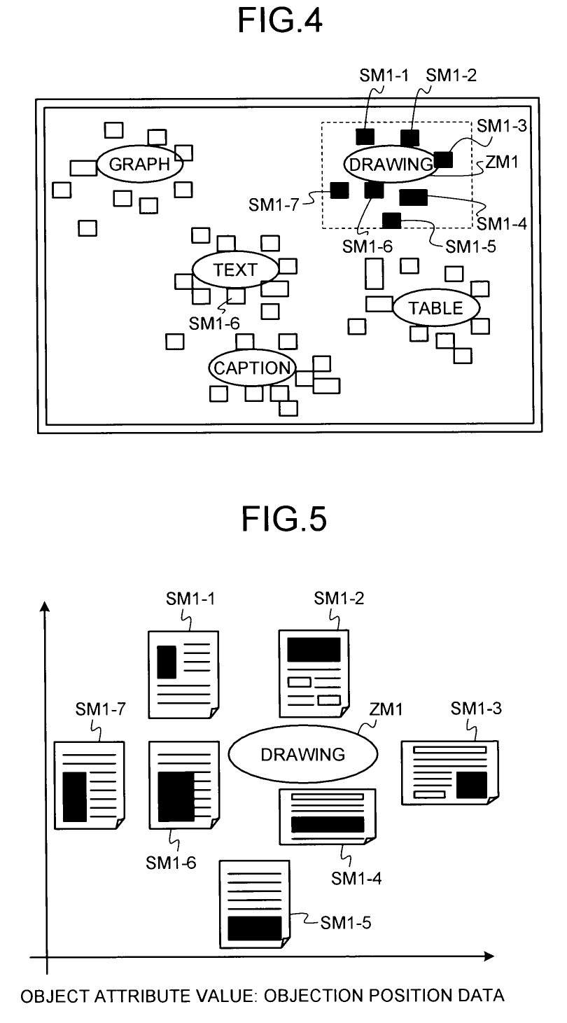

FIG. 4 is a schematic diagram of a thumbnail list image of a typical textual image. Thumbnails are grouped according to the object attribute, and thumbnails that contain objects of a common object attribute are arranged around each attribute name indicating the object attribute. For example, in FIG. 4, thumbnails SM1-1 to SM1-7 of images that contain objects belonging to an object attribute “drawing” are arranged around the object attribute “drawing” denoted by the reference symbol ZM1. FIG. 5 is a magnified view of a portion around the object attribute “drawing” in FIG. 4. The display position of each of the thumbnails SM1-1 to SM1-7 is determined by the position the object belonging to the object attribute occupies in the original image.

If the display target image includes a plurality of objects of different object attributes, as many thumbnails of the display target image as the object it includes are displayed on the display unit 102. For example, if the display target image includes the object of the object attribute “drawing” as well as the object of the object attribute “text”, one thumbnail of the image will be displayed in the vicinity of the attribute name “drawing” and one thumbnail of the image will be displayed in the vicinity of the attribute name “text” on the display unit 102 (for example, the thumbnail SM1-6 in FIG. 4).

The thumbnail list image enables the user to refine the search by using an object as the search key. The user can easily guess the display position of the thumbnail of the target image by recalling the general position of the object in the image. Thus, the user can perform search operations more effectively.

The display method of the thumbnail list image can be a simple thumbnail display. Alternatively, the target object can be displayed in high resolution or in highlight. Another display method can be that only the target object is displayed. Yet another display method can be to display the object within an outline of the image to give a general idea as to the position of the object in the image.

A self-organizing map can also be output by the process described above. For outputting the self-organizing map, the image processing device 100 retrieves the object attributes and the position data of the objects of the display target image and, based on these, creates feature quantity vectors. By using the self-organizing map, the image processing device 100 can project from the feature quantity space on to a two-dimensional plane, thus automating determination of the display positions of the objects.

The display target image is not limited to a still image; it can be a three-dimensional image or a moving image. In the case of a three-dimensional image, the image processing device 100 determines the display position of the thumbnail of the image that contains the object based on the center of gravity of the object and the pixel size of the original image, and arranges the thumbnail in the display area three-dimensionally. In the case of a moving image, a time axis (t) is added to the position axes to obtain the coordinate values (fx,fy,t). When displaying the thumbnail list image, the thumbnails of the moving image can be displayed and made to play at the same positions where the thumbnails of the two-dimensional image would have been displayed or the thumbnails of the moving image can be displayed in the display area three-dimensionally.

The object analyzing unit 103A can identify and retrieve the display target images at Step S1 based on a search condition input via the input unit 101.

An image processing device according to a second embodiment of the present invention is described below. The parts of the image processing device according to the second embodiment that are similar to those of the first embodiment have been assigned the same reference numerals and symbols, and the explanation thereof is repeated in some cases and not repeated in others.

The display-method determining unit 103B according to the first embodiment determines the display position of the thumbnail based on the position of the object in the original image. In the second embodiment, the display-method determining unit 103B determines the display position and display size of the thumbnail of the image that contains the object based on the image feature quantity of the object. Image feature quantity is obtained by quantification of image features such as texture, color, and edge distribution. For image feature quantity, common object attribute is not essential but it is preferable to use the image feature quantity that allows wide distribution of the objects.

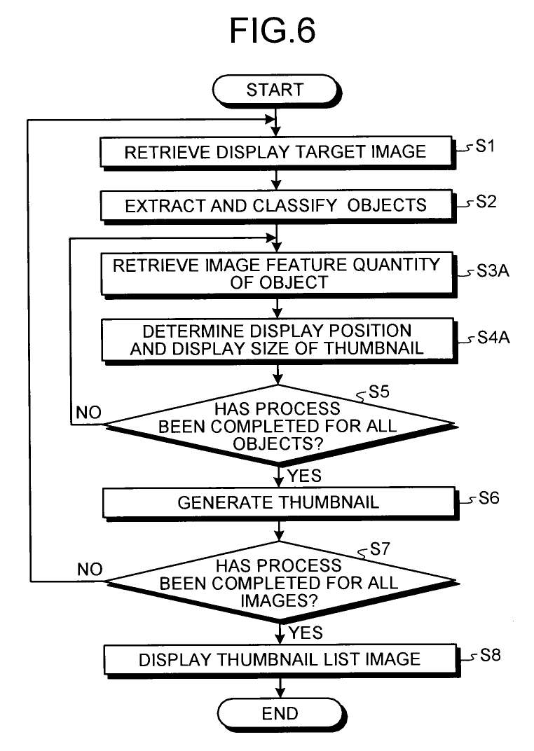

FIG. 6 is a flowchart of a thumbnail list image display process performed by the image processing device 100 according to the second embodiment. The steps in FIG. 6 that are identical to those in FIG. 3 are not described again. Therefore, Steps S1, S2, and S5 to S8 are not described here. The display-method determining unit 103B retrieves, for each object classified by object attribute by the object analyzing unit 103A, the image feature quantity included in the object data stored in the storage unit 104 (Step S3A). Based on the image feature quantity, the display-method determining unit 103B determines the display position and the display size of the thumbnail of the image that contains the object (Step S4A).

For determining the display position, a self-organizing map can be used whereby feature vectors are created from object attributes and image feature quantity and projection is made from the feature quantity space on to the two-dimensional plane. Alternatively, after determining the display position of each object attribute, the image feature quantity of the image that contains the object belonging to the object attribute is reflected in the display position of the thumbnail of the image. For determining the display size of the thumbnail based on the image feature quantity, a method disclosed in Japanese Patent Application Laid-open No. 2006-303707 can be used. According to the method, even if an image includes an object that cannot be easily identified unless the display size is large, an appropriate display size can be determined so as to enable the user to recognize the object.

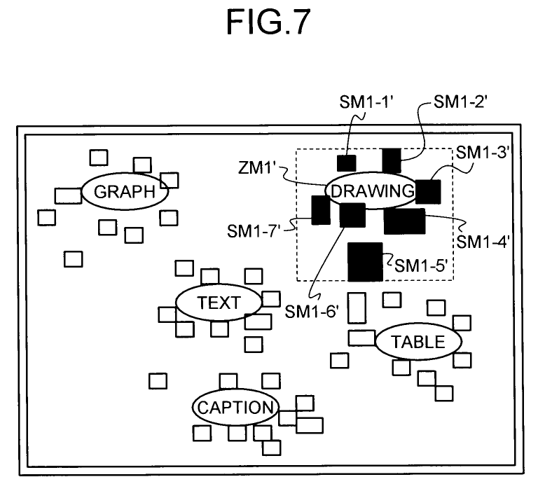

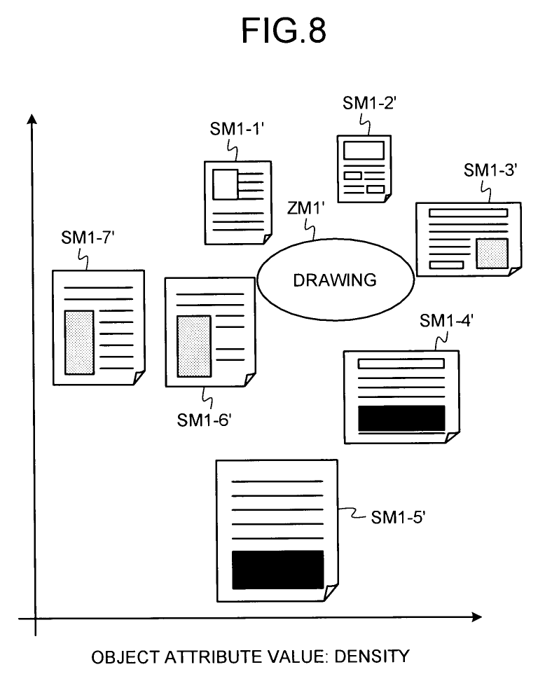

FIG. 7 is a schematic diagram of a thumbnail list image of a typical textual image input as display target images. Thumbnails are grouped according to object attribute, and thumbnails that contain objects of a common object attribute are arranged around each attribute name indicating the object attribute. For example, in FIG. 7, thumbnails SM1-1′ to SM1-7′ of the images that contain the object belonging to the object attribute “drawing” are arranged around the object attribute “drawing” denoted by the reference symbol ZM1′. FIG. 8 is a magnified view of the object attribute “drawing” denoted by the reference symbol ZM1′ and the thumbnails SM1-1′ to SM1-7′ around it. The display position of each of the thumbnails SM1-1′ to SM1-7′ is determined by the color density of the target object. The display size of each thumbnail is set based on the image feature quantity of the object so that the user can easily identify the object. Therefore, as against the display sizes of the thumbnails SM1-1 to SM1-7 shown in FIG. 5 being uniform, the display sizes of the thumbnails SM1-1′ to SM1-7′ shown in FIG. 7 are all different.

The configuration described above allows the object serving as the search key and the objects with similar image feature as that of the search key to be placed close together, with their display sizes adjusted according to the image feature such as frequency data, thus enabling the user to effectively find the desired image data from the thumbnail list image based on the object attribute and image feature quantity.

Other than the image feature quantity, data such as layout data that indicates the layout of objects and configuration data, which is data obtained by quantification of object configuration when an object is further broken down, can be used for determining the thumbnail display position.

An image processing device according to a third embodiment of the present invention is described below. The parts of the image processing device according to the third embodiment that are similar to those of the first and second embodiments have been assigned the same reference numerals and symbols, and the explanation thereof is repeated in some cases and not repeated in others.

In the third embodiment, an order of preference is set for object attributes, and the display-method determining unit 103B displays or hides the thumbnails of the images that contain the object according to the order of preference. The order of preference of the object attributes is input by the user via the input unit 101 and stored as part of object data in the storage unit 104.

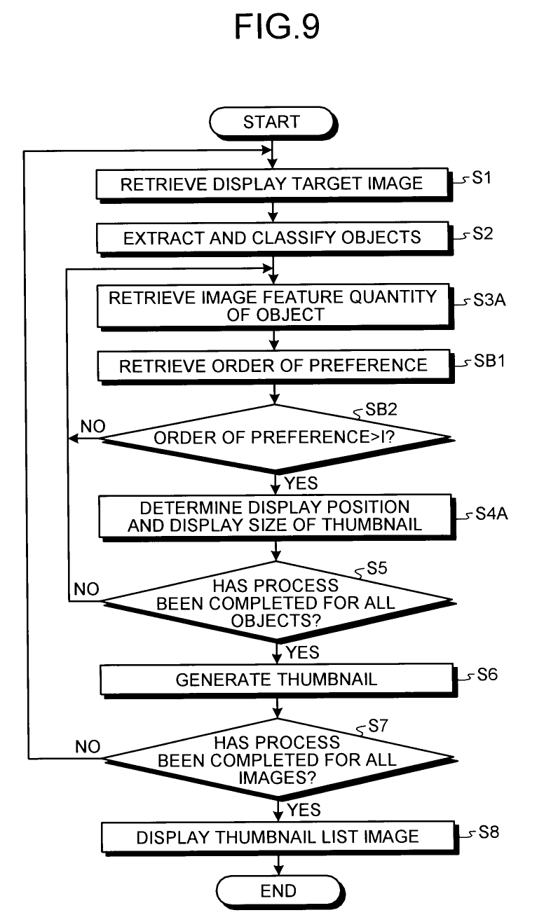

FIG. 9 is a flowchart of a thumbnail list image display process performed by the image processing device 100 according to the third embodiment. Steps S1, S2, and S3A are identical to those described with reference to the second embodiment. Next, at Step SB1, the display-method determining unit 103B retrieves the order of preference of the object attributes included in the object data stored in the storage unit 104. The display-method determining unit 103B then determines whether the retrieved order of preference is greater than a preset integer I of one or greater, and is stored in advance in the storage unit 104. If the order of preference is greater than I (Yes at Step SB2), the display-method determining unit 103B determines the display positions and the display sizes of the thumbnails of the images that contain the object based on the order of preference (Step S4A). The display-method determining unit 103B, for instance, sets more centrally the display position or sets higher in the display order the thumbnail of the image containing the object of the object attribute that is higher in the order of preference. The display-method determining unit 103B sets the display size of the thumbnails such that the higher the object attribute is in the order of preference, the larger the thumbnail of the image containing the object. The subsequent steps S5 to S8 are identical to those described with reference to the second embodiment. If the order of preference is not greater than I (No at Step SB2), the display-method determining unit 103B repeats Steps 3A to SB2 for the next object.

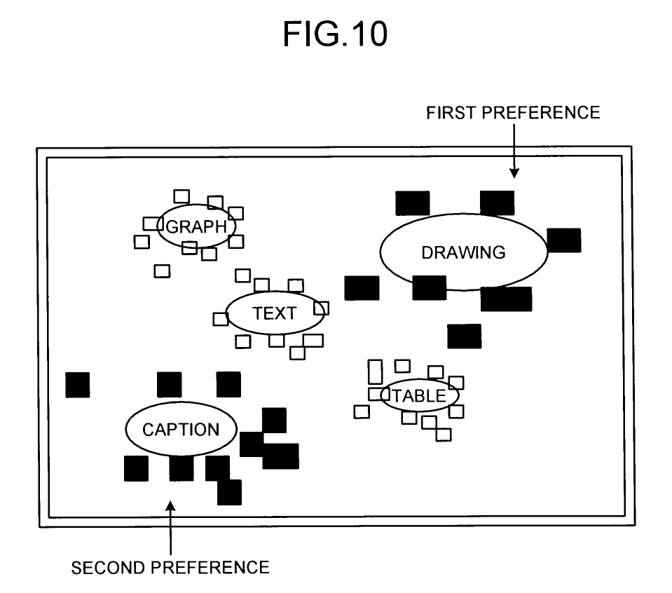

FIG. 10 is a schematic diagram of a thumbnail list image in which the thumbnails are displayed in different sizes according to the order of preference. The thumbnails are grouped according to the object attribute, and the thumbnails of the images that contain the object of an object attribute are arranged around each attribute name indicating the object attribute. In FIG. 10, the higher the object attribute is in the order of preference, the larger the display size is of the thumbnails of the images around the object attribute. If two thumbnails overlap, a thumbnail of higher object attribute can be displayed on top of the other thumbnail.

The configuration described above allows the thumbnails to be displayed according to the order of preference. Further, the thumbnails of the images that do not include an object of high preference are not displayed, making the search that much finer. Preferred thumbnail list image can be obtained as the thumbnails images containing the object of object attribute that is higher in the order of preference are displayed large.

Further, the configuration enables the thumbnails of the images containing an object of object attribute that is higher in the order of preference to be displayed more centrally in the area of the thumbnail list image that falls in the field of vision of the user, making it more convenient for the user to pick out the desired image more quickly.

The configuration enables adjustment of the display size of the thumbnails according to the order of preference. The thumbnails of the images containing the object of object attribute that is high in the order of preference is displayed in highlight, enabling the user to easily identify the desired image.

Further, the configuration enables determination of display order of the thumbnails according to the order of preference. Thus, the thumbnails of the images are displayed beginning with the object attribute of highest preference, shortening the search time and enabling the thumbnails to be displayed in the display order that is suited to the user's intent.

The display-method determining unit 103B can be configured to do away with step SB2, and directly determine, according to the order of preference, the display positions and the display sizes for all the objects in the display target image.

The display-method determining unit 103B can be configured to do away with step S3A and directly go to step SB1 after step S2. In this case, at least the display position or the display size can be determined.

An image processing device according to a fourth embodiment is described below. The parts of the image processing device according to the fourth embodiment that are similar to those of the second and third embodiments have been assigned the same reference numerals and symbols, and the explanation thereof is repeated in some cases and not repeated in others.

In the fourth embodiment, the display-method determining unit 103B sets the order of preference of an object attribute based on a query image specified as a search key for searching similar images, and determines the display position and the display size of the thumbnail based on the order of preference. It is supposed here that only one query image is specified as a search key. Specifically, the display-method determining unit 103B sets the order of preference of the object attribute of the objects contained in the query image by placing the object having the largest pixel size highest in the order of preference.

It is supposed here that the query images are stored in advance in the storage unit 104, and the user specifies a query image via the input unit 101. Specifically, the object analyzing unit 103A identifies the target image based on the image identification data the user inputs via the input unit 101, and retrieves the image as the query image.

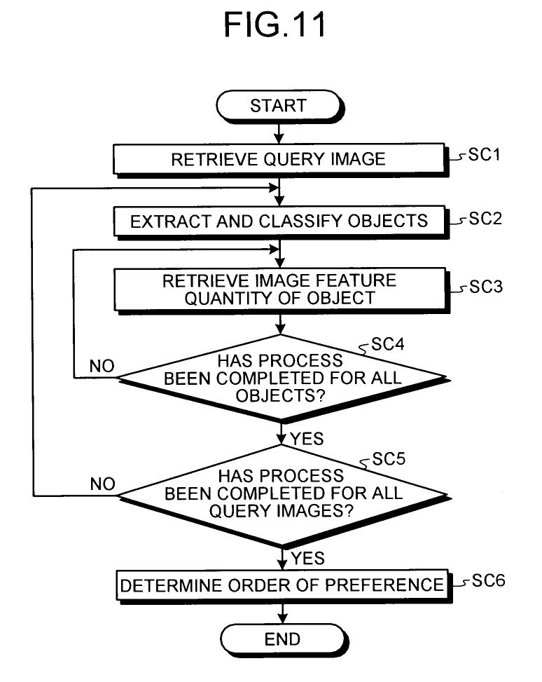

FIG. 11 is a flowchart of a thumbnail list image display process performed by the image processing device 100 according to the fourth embodiment. The object analyzing unit 103A of the image processing device 100 retrieves the query image (Step SC1), analyzes the query image, extracts the objects, and classifies the objects by object attribute (Step SC2). The object analyzing unit 103A then retrieves the image feature quantity of each object (Step SC3). As image feature quantity, the object analyzing unit 103A retrieves the pixel size of each object. The object analyzing unit 103A then checks whether the process has been completed for all the objects (Step SC4). If there are objects for which the process has not been completed (No at Step SC4), the object analyzing unit 103A repeats steps SC2 and SC3. If the process has been completed for all the objects (Yes at Step SC4), the object analyzing unit 103A checks whether the process has been completed for all the query images (Step SC5). If the process has been completed for all the query images (Yes at Step SC5), the display-method determining unit 103B sets the order of preference of the object attribute, placing the object that has the largest pixel size highest in the order of preference (Step SC6). If there are several objects of the same attribute in the query image, the object that has the largest pixel size is set as the representative object of the object attribute.

The steps subsequent to Step SC6 are not shown in FIG. 11. However, Steps S4A to S8 shown in FIG. 9 follow Step SC6. At Step S4A, the display-method determining unit 103B determines the display position and the display size of the thumbnail, placing more centrally or setting higher in the display order, and displaying in larger size the thumbnail of the image containing the object belonging to the object attribute that is higher in the order of preference.

Thus, in the configuration described above, the order of preference can be set based on a query image, enabling the user to perform search based on any vague image feature. The thumbnails of the images containing the object of object attribute that is high in the order of preference is displayed in highlight, enabling the user to easily identify the desired image.

The order of preference can also be set based on the number of object attributes in the query image, setting highest preference to the object attribute of the object that has highest count.

When there is a plurality of query images, the order of preference needs to be set taking into account all the objects in all the query images. In this case, at Step SC6, the display-method determining unit 103B sets the order of preference of the object attributes by one of the methods described below:

(a) Setting the object attribute of the object that has a higher count in the query images higher in the order of preference

(b) Setting the object attribute of the object whose distribution is sparser in the query images (in other words, from among the query images, the object having most similar image features) higher in the order of preference

Specifically, at Step SC6, the display-method determining unit 103B calculates the distribution of the image feature quantity of each object contained in the query images, and sets the object attribute of the object that has sparser distribution higher in the order of preference.

Thus, by setting the order of preference of the object attributes based on the similarity of the objects in the query images, the thumbnails sought by the user can be displayed more effectively.

Although the invention has been described with respect to specific embodiments, the constituent elements can be modified within a scope not deviating from the purport of the invention. In addition, various inventions can be formed by combining a plurality components disclosed in the embodiments appropriately. For example, some components from among the components described in the above embodiments can be omitted. Further, components from different embodiments can be combined.

The image processing device 100 can be configured such that the computer programs executed by it can be downloaded over a network, such as the Internet, from a computer connected to the network. Alternatively, the programs can be made available as installable files or executable files on a computer-readable recording medium such as compact disk-read-only memory (CD-ROM), flexible disk (FD), compact disk-rewritable (CD-R), and digital versatile disk (DVD).

In the embodiments described above, the display target image and the query image are read from the storage unit 104. However, the image processing device 100 can be configured to retrieve the images from a computer connected to the Internet or from a computer-readable recording medium such as CD-ROM, FD, CD-R, and DVD.

The image processing device 100 can be a computer, copier, printer, facsimile machine, or a multifunction peripheral equipped with functions such as copying, printing function, and facsimile.

The image processing device 100 in the embodiments described above includes the input unit 101 and the display unit 102. However, the input unit 101 and the display unit 102 can be done away with, and the image processing device can be connected to the outside by a cable or wirelessly.

According to the present invention, image search can be performed effectively by focusing on specific objects of an image such as captions, drawings, tables, and graphs accompanying text, partial images of a photographic image, etc.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device comprising:
a classifying unit that analyzes a display target image and classifies an object included in the display target image based on an attribute of the object;
a feature-data retrieving unit that retrieves feature data that indicates a feature of the object;
a display-method determining unit that sets, based on the feature data, at least one of a display position and a display size of a thumbnail of the display target image that includes the object; and
a thumbnail generating unit that generates the thumbnail of the display target image,
wherein the thumbnail generating unit creates a thumbnail list image by at least one of generating the thumbnail in the display size set by the display-method determining unit and arranging the thumbnail in the display position set by the display-method determining unit.

2. The image processing device according to claim 1, wherein the feature data is at least one of position data that indicates a position, image feature data that indicates an image feature, layout data that indicates a layout, and configuration data that indicates a configuration of the object in the display target image that includes the object.

3. The image processing device according to claim 1, further comprising a first image-retrieving unit that retrieves an image that matches with a search condition as the display target image.

4. The image processing device according to claim 1, further comprising a display unit that displays the thumbnail list image created by the thumbnail generating unit.

5. An image processing device comprising:
a classifying unit that analyzes a display target image and classifies an object included in the display target image based on an attribute of the object;
a preference setting unit that sets an order of preference of the attributes;
a display-method determining unit that sets, based on the order of preference, at least one of a display position and a display size of a thumbnail of the display target image that includes the object; and
a thumbnail generating unit that generates the thumbnail of the display target image,
wherein the thumbnail generating unit creates a thumbnail list image by at least one of generating the thumbnail in the display size set by the display-method determining unit and arranging the thumbnail in the display position set by the display-method determining unit.

6. The image processing device according to claim 5, wherein the display-method determining unit does not display the thumbnail of the image that does not include the object classified by attribute having an order of preference greater than a predetermined value.

7. The image processing device according to claim 5, wherein the display-method determining unit sets the display position more centrally for the attribute that is higher in the order of preference.

8. The image processing device according to claim 5, wherein the display-method determining unit sets the display size larger for the attribute that is higher in the order of preference.

9. The image processing device according to claim 5, wherein the display-method determining unit sets higher in a display order the thumbnail of the display target image containing the object of the object attribute that is higher in the order of preference.

10. The image processing device according to claim 5, further comprising an input receiving unit that receives information indicative of the order of preference of the attributes from a user,
wherein the preference setting unit sets the order of preference based on the information received by the input receiving unit.

11. The image processing device according to claim 5, further comprising a second image-retrieving unit that retrieves a query image as a search key for searching a similar image,
wherein the preference setting unit sets the order of preference based on the objects included in the query image.

12. The image processing device according to claim 11, wherein the preference setting unit sets the order of preference based on the number of objects included in the query image for each attribute.

13. The image processing device according to claim 11, further comprising a feature-data retrieving unit that retrieves feature data that indicates features related to each object classified by the classifying unit,
wherein the preference setting unit sets higher in the order of preference the attribute, from among the attributes of the objects included in the query image, that has a sparser distribution based on the feature data retrieved by the feature-data retrieving unit.

14. The image processing device according to claim 5, further comprising a display unit that displays the thumbnail list image created by the thumbnail generating unit.
